(19) United States
(12) Patent Application Publication
(10) Pub. No.: US 2025/0310998 A1
(43) Pub. Date: Oct. 2, 2025

(54) PRIORITIZED CHANNEL ACCESS PROCEDURES FOR WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/087,382

(22) Filed: Mar. 21, 2025

Related U.S. Application Data
(60) Provisional application No. 63/571,966, filed on Mar. 29, 2024.
(60) Provisional application No. 63/571,959, filed on Mar. 29, 2024.
(60) Provisional application No. 63/723,434, filed on Nov. 21, 2024.
(60) Provisional application No. 63/728,529, filed on Dec. 5, 2024.
(60) Provisional application No. 63/743,812, filed on Jan. 10, 2025.

(51) Int. Cl. H04W 74/0816; H04W 12/06; H04W 74/08

(52) U.S. Cl. CPC H04W 74/0816; H04W 12/06; H04W 74/0875

(57) ABSTRACT

An embodiment includes a station (STA) may obtain authorization from an access point (AP) to transmit defer signals that block other STAs from contending for a wireless medium for a certain period of time and the STA can be assisted in obtaining channel access to transmit low latency frames, whereby the AP may control the number of STAs that can send such a defer signal to help reduce channel access latency and improve network performance.

### CROSS-REFERENCE TO RELATED APPLICATIONS

This application claims the benefit of priority from U.S. Provisional Application No. 63/571,966, entitled “ASSISTANCE FRAMEWORK FOR NEXT GENERATION WLANS” filed Mar. 29, 2024; U.S. Provisional Application No. 63/571,959, entitled “MEMBERSHIP MANAGEMENT FOR NEXT GENERATION WLANS” filed Mar. 29, 2024; U.S. Provisional Application No. 63/723,434, entitled “MEMBERSHIP MANAGEMENT FOR NEXT GENERATION WLANS” filed Nov. 21, 2024; U.S. Provisional Application No. 63/728,529, entitled “MEMBERSHIP MANAGEMENT FOR NEXT GENERATION WLANS” filed Dec. 5, 2024; and U.S. Provisional Application No. 63/743,812, entitled “MEMBERSHIP MANAGEMENT FOR NEXT GENERATION WLANS” filed Jan. 10, 2025, which are all incorporated herein by reference in their entireties.

### TECHNICAL FIELD

This disclosure relates generally to a wireless communication system, and more particularly to, for example, but not limited to, prioritized channel access in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure include a station (STA) in a wireless network, the STA comprising a memory; and a processor coupled to the memory. The processor configured to transmit a defer signal to block one or more STAs from contending for a channel during a time period. The processor is configured to contend for the channel and obtain access to the channel. The processor is configured to transmit, to an access point (AP), one or more frames via the channel.

In some embodiments, the processor is further configure to transmit, to the AP, a first frame that requests authorization to transmit a defer signal that blocks one or more other STAs associated with the AP from contending for a channel; and receive, from the AP, a second frame that authorizes the transmission of the defer signal in response to the first frame.

In some embodiments, the processor is further configured to determine that a number of retransmissions of a frame is greater than a threshold prior to transmitting the defer signal.

In some embodiments, the processor is further configured to determine that a buffering delay for transmitting a frame is greater than a predetermined threshold prior to transmitting the defer signal.

In some embodiments, the processor is further configured to determine that a number of transmission attempts of the defer signal is less than a threshold prior to transmitting the defer signal.

In some embodiments, the processor is further configured to: receive, from the AP, a frame that revokes the authorization to transmit the defer signal; and abstain from transmitting the defer signal in response to receiving the frame.

In some embodiments, the processor is further configured to receive, from the AP, a frame that includes a prioritized enhanced distributed channel access parameter set that provides high priority to the STA that is allowed to transmit low latency traffic.

In some embodiments, the processor is further configured to determine that a particular frame is within a threshold of an expiration time of the particular frame prior to transmitting the defer signal.

In some embodiments, the processor is further configured to receive, from the AP, a frame that includes one or more information associated with eligibility for transmitting the defer signal.

In some embodiments, the processor is further configured to receive, from the AP, a frame that advertises one or more thresholds for becoming eligible to transmit the defer signal.]

One aspect of the present disclosure provides an access point (AP) in a wireless network, the AP comprising: a memory; and a processor coupled to the memory. The processor is configured to receive, from a station (STA), a first frame that requests authorization to transmit a defer signal that blocks one or more other STAs associated with the AP from contending for a channel. The processor is configured to transmit, to the STA, a second frame that authorizes the transmission of the defer signal in response to the first frame. The processor is configured to receive, from the STA, one or more frames via the channel.

In some embodiments, the processor is further configured to transmit, to the STA, a frame that revokes the authorization to transmit the defer signal.

In some embodiments, the second frame includes a prioritized enhanced distributed channel access parameter set that provides high priority to the STA that is allowed to transmit low latency traffic.

In some embodiments, the first frame includes timing information regarding an expiration time of a particular frame of the STA.

In some embodiments, the second frame includes one or more information associated with eligibility for transmitting the defer signal.

One aspect of the present disclosure provides a computer-implemented method for communication by a station (STA) in a wireless network. The method comprises transmitting a defer signal to block one or more STAs from contending for the channel during a time period. The method comprises contending for the channel and obtain access to the channel. The method comprises transmitting, to the AP, one or more frames via the channel.

In some embodiments, the method further comprises transmitting, to the AP, a first frame that requests authorization to transmit a defer signal that blocks one or more other STAs associated with the AP from contending for a channel; and receiving, from the AP, a second frame that authorizes the transmission of the defer signal in response to the first frame

In some embodiments, the method further comprises determining that a number of retransmissions of a frame is greater than a threshold prior to transmitting the defer signal.

In some embodiments, the method further comprises determining that a buffering delay for transmitting a frame is greater than a predetermined threshold prior to transmitting the defer signal.

In some embodiments, the method further comprises determining that a number of transmission attempts of the defer signal is less than a threshold prior to transmitting the defer signal.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example of transmission of a defer signal in accordance with an embodiment.

FIG. 5 illustrates a flow chart of an example process by an STA of transmitting a defer signal in accordance with an embodiment.

FIG. 6 illustrates a flow chart of an example process by an AP granting membership to one or more of its associated STAs in accordance with an embodiment.

FIG. 7 illustrates a flow chart of an example process by an AP of granting an unsolicited membership to a STA in accordance with an embodiment.

FIG. 8 illustrates a traffic profile based prioritized EDCA authorization in accordance with an embodiment.

FIG. 9 illustrates a flow chart of an example process by a STA to transmit a defer signal based on a number of transmissions in accordance with an embodiment.

FIG. 10 illustrates a flow chart of an example process by a STA to transmit a defer signal based on an expiration time in accordance with an embodiment.

FIG. 11 illustrates a flow chart of an example process by a STA to transmit a defer signal based on a number of transmissions in accordance with an embodiment.

FIG. 12 illustrates a format for a parameter set element in accordance with an embodiment.

FIG. 13 illustrates a parameter set element format in accordance with an embodiment.

FIG. 14 illustrates a flow chart of an example process for a quality of service (QOS) setup based authorization in accordance with an embodiment.

FIG. 15 illustrates a flow chart of an example process by an AP of providing a restricted target-wake-time (R-TWT) setup based authorization in accordance with an embodiment.

FIG. 16 illustrates an example assistance from an AP in accordance with an embodiment.

FIG. 17 illustrates an AP clearing a channel for an STA in accordance with an embodiment.

FIG. 18 illustrates an AP transmitting a defer signal based on an indication by the STA in accordance with an embodiment.

FIG. 19 illustrates an AP transmitting a defer signal to aid a low latency STA at the start of an R-TWT SP in accordance with an embodiment.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

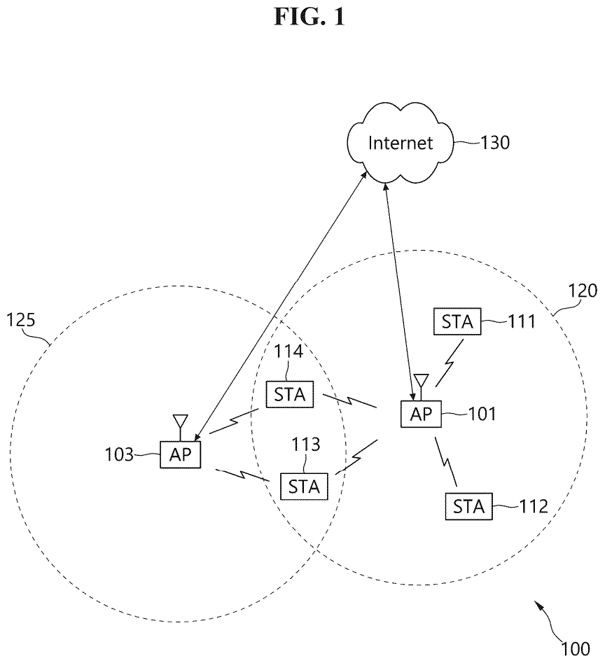

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

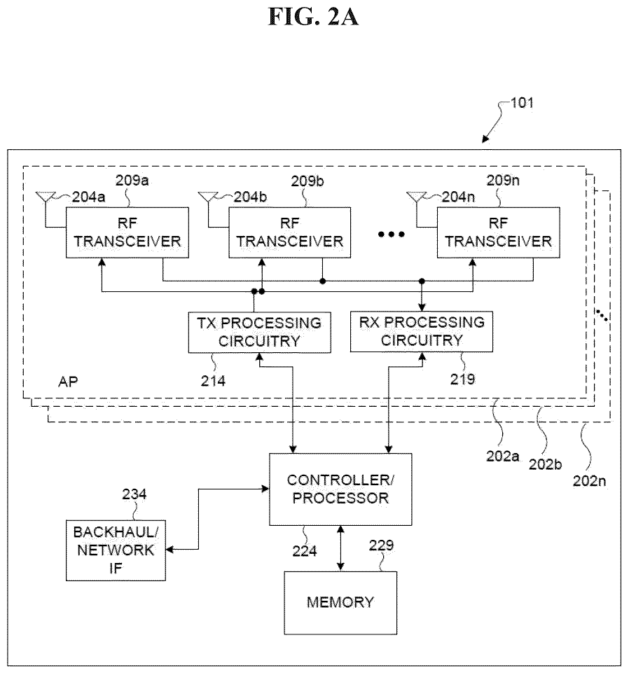

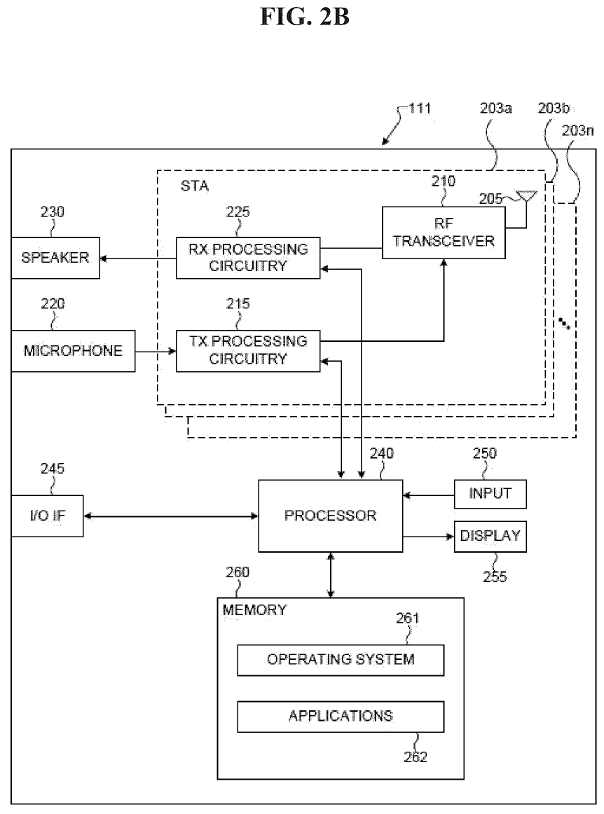

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

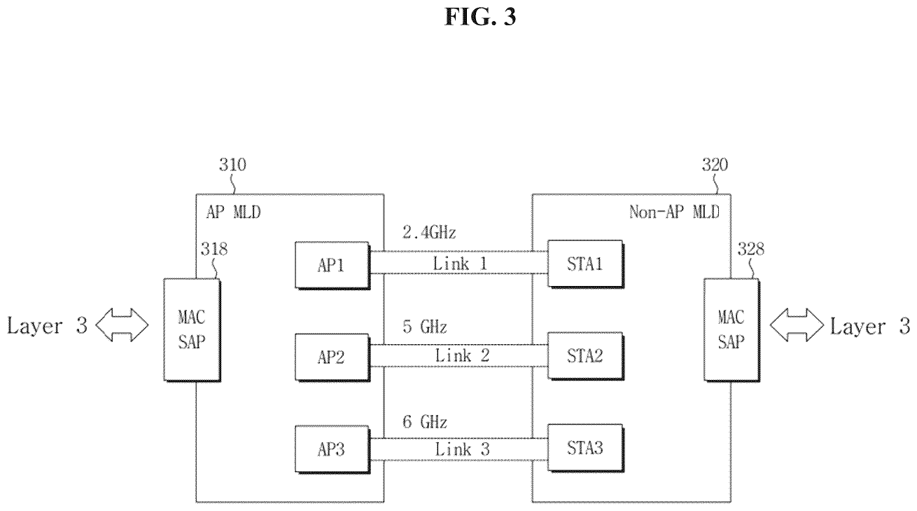

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D5.0, “Wireless LAN Medium Access Control (MAC) and Physical Layer (PHY) Specifications.

A device (e.g., STA) may encounter a channel access delay when attempting to transmit frames. To reduce latencies for channel access, in a medium access protocol based on a Distributed Coordination Function (DCF), devices may use Carrier Sense Multiple Access with Collision Avoidance (CSMA/CA) coupled with a random backoff procedure. Devices may also need to defer to ongoing transmissions on the channel to avoid collisions or interference from the ongoing transmissions. The channel access duration may increase with an increase in defer time to other STAs on the same channel. In dense networks, this can act as a bottleneck which would need to be addressed in order to reduce delays and provide support for ultra-low latency (LL) applications. For some STAs that have latency sensitive traffic, the impact of this channel access delay can be high. For example, for some applications, the channel access delay of wireless networks may make it difficult to support an application's operation as the packets can expire during the channel access phase.

Embodiments in accordance with this disclosure may block other STAs from accessing the channel to reduce the amount of contention on the wireless medium. In some embodiments, a STA with a low latency traffic backlog may transmit a defer signal (DS), which may be referred to herein as a blocking signal, defer message, or blocking message, in order to block other devices (e.g., devices that cannot or have not transmitted such a defer signal, among others) from contending for the wireless medium for a certain period of time. In some embodiments, a defer signal is a signal that prevents a different STA (e.g., a legacy STA) from contending for channel access. In some embodiments, a defer signal can be designed such that it can cause the PHY-RXEND.indication primitive to include an error or a frame for which the frame check sequence (FCS) value is incorrect. In some embodiments, the defer signal's modulation can be used to control the duration for which a legacy STA is blocked from contending for the wireless medium. In some embodiments, depending on a modulation scheme, a legacy device may compute an extended interframe space (EIFS) duration which may vary based on the modulation scheme of a frame that pushed the legacy device into the EIFS state, and the EIFS duration may be a time during which the legacy device will not access the channel. Blocking other devices from contending for the wireless medium for a certain period of time may be referred to herein as a protected short contention period, prioritized EDCA, or enhanced EDCA. In particular, a protected short contention period may be a duration of time during which other devices are blocked from contending for a channel and only the devices that have transmitted a defer signal may contend for the channel.

However, if a device with low latency traffic starts to transmit a defer signal, this can degrade the performance of low latency applications running on legacy devices. Accordingly, procedures to control the number of devices that can send such a defer may be beneficial.

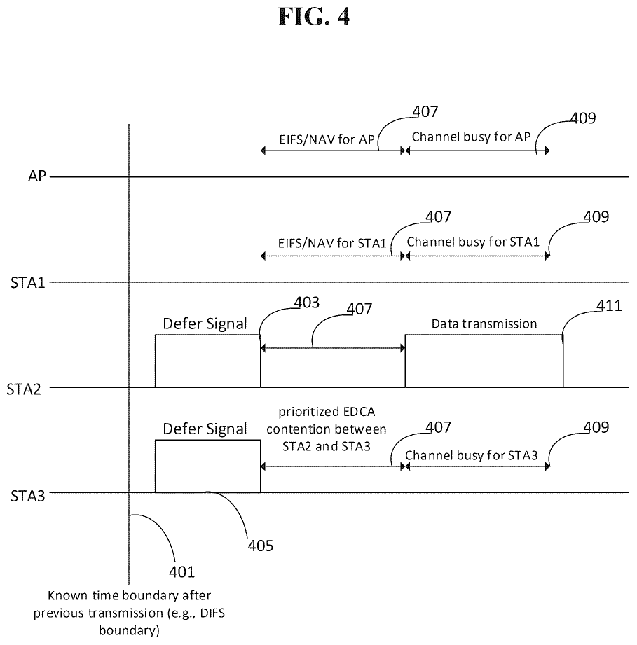

FIG. 4 illustrates an example of transmission of a defer signal in accordance with an embodiment. In particular, FIG. 4 illustrates communication among an AP, STA1, STA2 and STA3. After a known time boundary 401, STA2 and STA3 both transmit respective defer signals 403 and 405. The defer signals 403 and 405 may be used to block the other devices, AP and STA1, from contending for the wireless medium for a certain period of time. Accordingly, during time period 407, the AP is in an extended interframe space (EIFS) or has set a network allocation vector (NAV) whereby the AP does not transmit anything during this time period. Similarly, STA 1 is in an EIFS or has set a NAV whereby the STA does not transmit anything during this time period. As a result, there is a prioritized EDCA contention between STA2 and STA3 for the channel access. During time period 409, STA2 obtains channel access and thus performs a data transmission 411, while the channel is unavailable for the AP, STA1, and STA3.

There can be many situations where an STA may need to gain channel access or may need some assistance from the AP. An AP may also face delays in order to access the channel (e.g., due to a large number of devices). In such a situation, there can be a need for the AP to block the channel from other devices to be able to help the STA. Embodiments in accordance with this disclosure provide techniques that improve the AP's ability to assist an STA in order for the STA to gain channel access.

In some embodiments, an AP can grant membership to one or more of its associated STAs authorizing them to transmit a defer signal. The membership can be granted in an unsolicited manner or it can be granted upon request from an STA.

In some embodiments, the STA can transmit a membership request message that can include at least one or more of the information items as indicated in Table 1.

Table 1 illustrates a membership request message content in accordance with an embodiment.

TABLE 1

| Information | |
|---|---|
| item | Description |
| Request | An information item that can indicate that the STA is requesting for an |
| indication | authorization to transmit the defer signal. Examples of request indication |
| | can be as shown in Table 2 below. |
| Duration | An information item that can indicate the duration for which the |
| | membership is being requested. |
| Traffic type | An information item that can indicate the type(s) of traffic for which the |
| | membership is being requested. e.g., traffic identifiers (TIDs), access |
| | categories (ACs), stream classification service (SCS) IDs, unique identifiers |
| | for traffic streams, among others. In some embodiments, this can be done |
| | by including a TID bitmap, AC bitmap, traffic classification (TCLAS) |
| | element(s) coupled with TCLAS processing element(s). |
| STA | An information item that can indicate the STA for which the request can be |
| identifier | made. e.g., this can be a STA requesting for itself or for another STA (e.g., |
| | a relay requesting for its own devices, a helper STA such as a hub device |
| | requesting authorization for one of the devices in the network). |
| Request start | An information item that can describe the start time of the request. e.g., |
| time | number of target beacon transmit times (TBTTs) from the current TBTT |
| indication | when the STA wants to be authorized for transmission, duration in terms of |
| | time units (TUs), among others. |
| Traffic | One or more information items that can describe the traffic characteristics |
| characteristics | of the traffic stream for which the membership is being requested. e.g., |
| | quality of service (QoS) characteristic element or one or more information |
| | items therein. |

The information items in Table 1 can be transmitted together or separately. They can be transmitted as a part of any existing frame, element, field or subfield in the standard or can be a part of newly defined ones.

Table 2 illustrates examples of request indications in accordance with an embodiment.

TABLE 2

| Example | Description |
|---|---|
| Reason code | A reason code that can explain that the reason for transmitting the message |
| | is to request an authorization for transmitting the defer signal or to grant the |
| | authorization. |
| Indication | A field (e.g., a bit) that can take a predetermined value (e.g., 1) to make the |
| field | indication and another predetermined value (e.g., 0) to indicate otherwise. |
| Implicit | An implicit indication can mean that transmitting a certain type of frame |
| indication | can be considered as an indication of a request. e.g., if there is a dedicated |
| | request/response frame. |

Upon receiving the membership request message, the AP can transmit a membership response message to the STA. The response message can include at least one or more of the information items as shown in Table 3.

Table 3 illustrates a membership response message content in accordance with an embodiment.

TABLE 3

| Information | |
|---|---|
| item | Description |
| Response | An information item that can indicate that the AP is responding to the |
| indication | STA's request for an authorization to transmit the defer signal. Examples |
| | of request indication can be as shown in Table 2. |
| Response | An information item that can indicate the AP's response. e.g., status code |
| indication | indicating the status of the request is success. |
| Duration | An information item that can indicate the duration for which the |
| | membership can be granted. |
| Traffic type | An information item that can indicate the type(s) of traffic for which the |
| | membership can be granted. e.g., traffic identifiers (TIDs), access |
| | categories (ACs), stream classification service (SCS) IDs, unique |
| | identifiers for traffic streams, among others. In some embodiments, this |
| | can be done by including a TID bitmap, AC bitmap, traffic classification |
| | (TCLAS) element(s) coupled with TCLAS processing element(s). |
| STA identifier | An information item that can indicate the STA for which the grant has |
| | been made. |
| Granted start | An information item that can describe the start time of |
| time indication | membership/authorization for the STA. e.g., number of target beacon |
| | transmit time (TBTTs) from the current TBTT when the STA can be |
| | authorized for transmission, duration in terms of time units (TUs), among |
| | others. |

The information items in Table 3 can be transmitted together or separately. They can be transmitted as a part of any existing frame, element, field, or subfield in the standard or can be a part of newly defined ones. The membership authorization response messages can also be transmitted in an unsolicited manner.

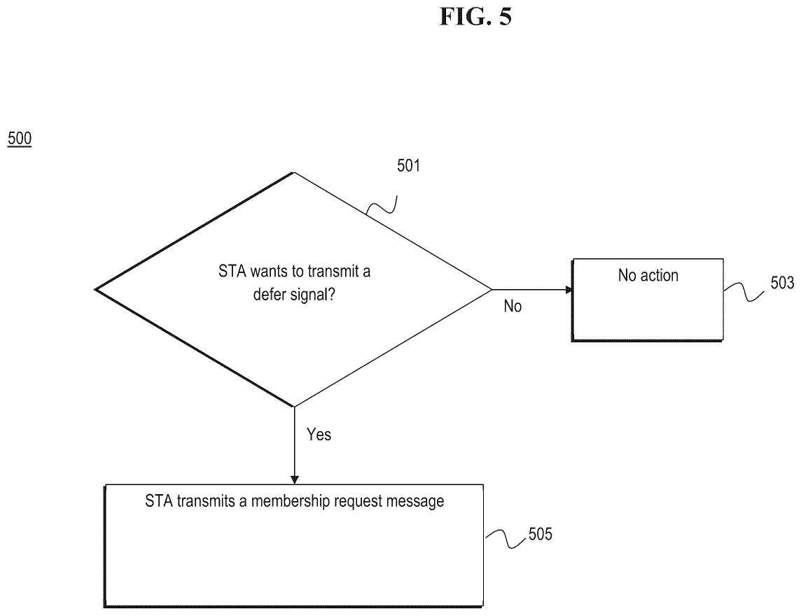

FIG. 5 illustrates a flow chart of an example process by an STA of transmitting a defer signal in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 5 illustrates operations performed in a STA, such as the STA illustrated in FIG. 3.

The process 500, in operation 501, the STA determines whether the STA wants to transmit a defer signal. If the STA determines that it does not want to transmit a defer signal, then in operation 503, the STA performs no action. If the STA determines that it does want to transmit a defer signal, the process proceeds to operation 505.

In operation 505, the STA transmits to an AP a membership request message. In some embodiments, the membership request message can include information as set forth in Table 1. In particular, the request message can include a request indication that the STA is requesting authorization from the AP to transmit a defer signal. The request message can include a duration that indicates the duration for which membership is being requested. The request message can include a traffic type that indicates the type of traffic for which membership is being requested. The request message can include a start time indication that describes the start time of the request. The request message can include traffic characteristics information that describes the traffic characteristics of the traffic stream for which membership is being requests (e.g., QoS characteristics of the traffic stream.

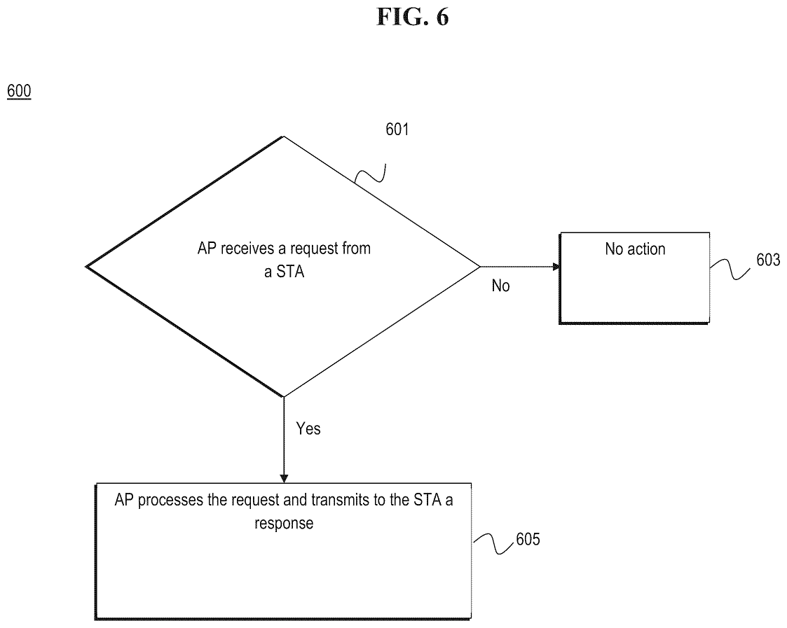

FIG. 6 illustrates a flow chart of an example process by an AP granting membership to one or more of its associated STAs authorizing them to transmit a defer signal in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 6 illustrates operations performed in an AP, such as the AP illustrated in FIG. 3.

The process 600, in operation 601, the AP determines whether it receives a request from a STA that requests authorization to transmit a defer signal. If the AP does not receive a request from the STA, the process proceeds to operation 603 where the AP performs no action. If the AP does receive a request from the STA, the process proceeds to operation 605.

In operation 605, the AP processes the request and transmits to the STA a response message. In some embodiments, the response message can include one or more of the information items provided in Table 3. The response message may include a response indication that indicates that the AP is responding to the STA's request for an authorization to transmit a defer signal. The response message may include a response indication indicating the AP's response to the request (e.g., status code indicating the status of the request, such as success or deny among others). The response message may include duration information that indicates the duration for which membership is granted. The response message may include traffic type information that indicates the types of traffic for which membership is granted. The response message may include one or more STA identifiers that identify the STA(s) for which that grant has been made. The response message may include a grant start indication time that indicates a start time of membership or authorization for the STA.

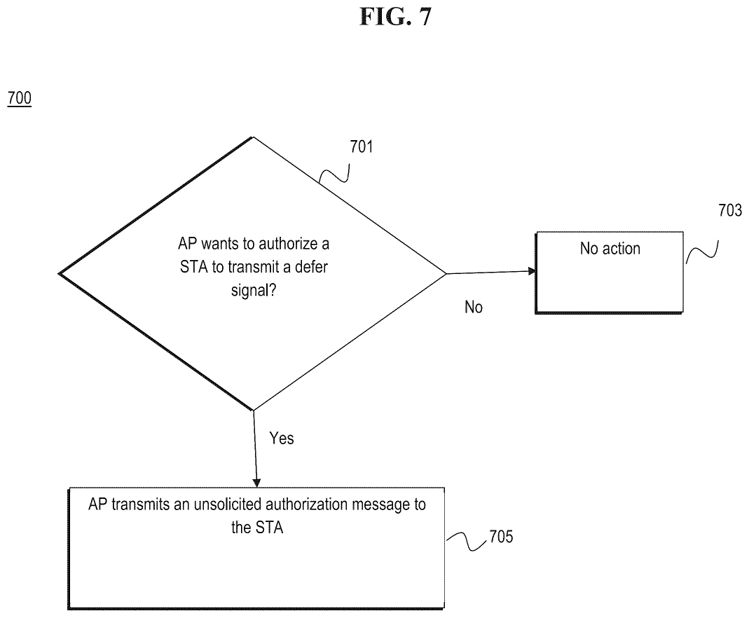

FIG. 7 illustrates a flow chart of an example process by an AP of granting an unsolicited membership to a STA in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 7 illustrates operations performed in an AP, such as the AP illustrated in FIG. 3.

The process 700, in operation 701, the AP determines whether the AP wants to authorize a STA to transmit a defer signal. If the AP determines that it does not want to authorize the STA to transmit a defer signal, the process proceeds to operation 703 where the AP performs no action. If the AP determines it does want to authorize the STA to transmit a defer signal, the process proceeds to operation 705.

In operation 705, the AP transmits an unsolicited authorization message to the STA. In some embodiments, the authorization message may include the information set out in Table 3.

In some embodiments, membership can be obtained for usage of defer signals (blocking messaging) for a specific set of frames (e.g., access categories (ACs), TIDs, among others). In some embodiments, some ACs can obtain membership whereas some can be allowed by default.

In some embodiments, a membership can be obtained by enhancing one or more existing procedures or implemented new procedures (e.g., enhancement of stream classification service (SCS) procedures or messages). The SCS request frame can include an information item (e.g., a bit of flag) that can indicate that the request is for a prioritized EDCA authorization for that particular traffic profile. In some embodiments, there can be a traffic profile for which prioritized EDCA can be authorized or the device can be allowed to send a defer signal.

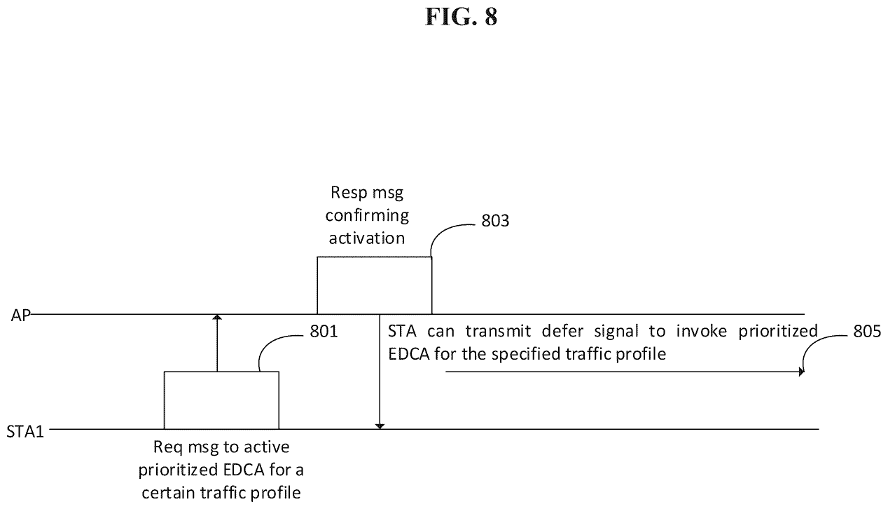

FIG. 8 illustrates a traffic profile based prioritized EDCA authorization in accordance with an embodiment. In particular, FIG. 8 illustrates communication between an AP and STA1, where STA1 may have been authorized for prioritized EDCA for a certain traffic profile using a modified SCS request message and response message exchange. If STA1 has traffic of that particular traffic profile, then STA1 can transmit a request message 801 to activate prioritized EDCA using the defer signal. The AP can transmit a response message 803 that authorizes the prioritized EDCA in response to the request message 801. Following this and starting with time period 805, STA1 can start transmitting the defer signal to activate prioritized EDCA for a specified traffic profile. In some embodiments, if STA1 has been authorized for prioritized EDCA for a specific traffic profile, then STA1 can transmit the defer signal whenever it has traffic corresponding to that traffic profile.

In some embodiments, if a device has a low latency (LL) traffic whose delay tolerance is below a predetermined threshold, then the device can transmit a defer signal. In some embodiments, if the device has a LL frame whose tolerance is less than the channel access delay for the wireless medium, then the device can transmit a defer signal. In some embodiments, a predetermined threshold can be devices which have latency tolerance on the order of a few milliseconds. In some embodiments, a STA can transmit a defer signal if its LL frame is close to expiration. In some embodiments, a STA may transmit a defer signal when buffering delay for MAC service data units (MSDUs) of a traffic stream with known delay bounds approaches a threshold value.

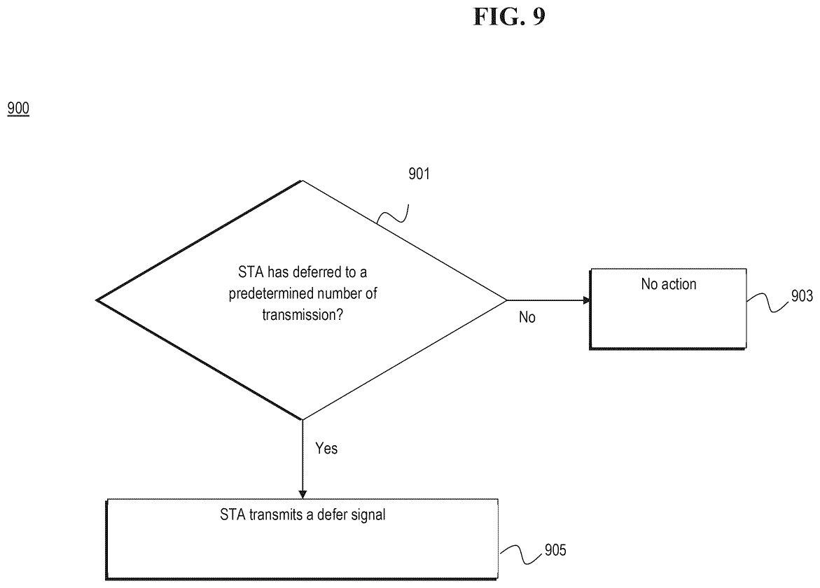

FIG. 9 illustrates a flow chart of an example process by a STA to transmit a defer signal based on a number of transmissions in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 9 illustrates operations performed in a STA, such as the STA illustrated in FIG. 3.

The process 900, in operation 901, the STA determines whether the STA has deferred to a predetermined number of transmissions. If the STA determines that it has not deferred to a predetermined number of transmissions, the process proceeds to operation 903 where the STA performs no action. If the STA determines that it has deferred to a predetermined number of transmissions, the process proceeds to operation 905.

In operation 905, the STA transmits a defer signal. In some embodiments, the defer signal may block other devices (e.g., devices that cannot or have not transmitted such a defer signal, among others) from contending for the wireless medium for a certain period of time.

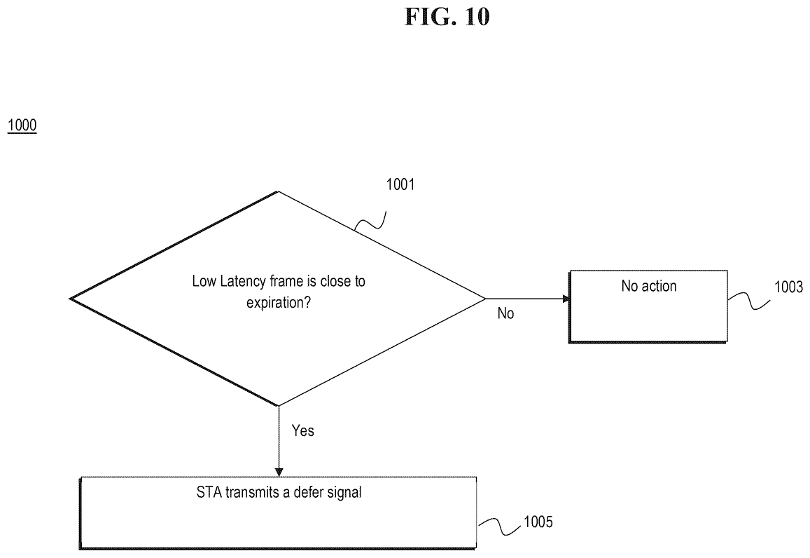

FIG. 10 illustrates a flow chart of an example process by a STA to transmit a defer signal based on an expiration time in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a STA, such as the STA illustrated in FIG. 3.

The process 1001, in operation 1001, the STA determines whether the STA has a low latency frame that is close to expiration. If the STA determines that it has no low latency frame that is close to expiration, the process proceeds to operation 1003 where the STA performs no action. If the STA determines that it has a low latency frame that is close to expiration, the process proceeds to operation 1005.

In operation 1005, the STA transmits a defer signal.

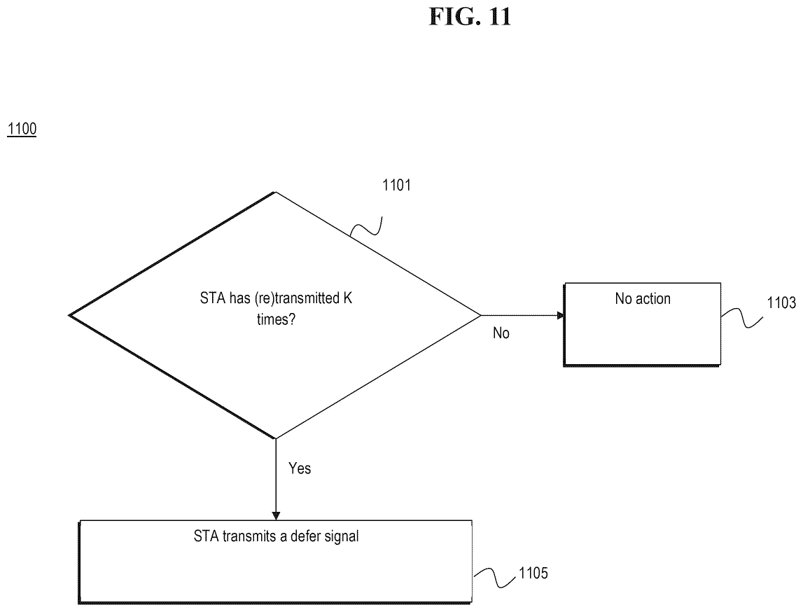

FIG. 11 illustrates a flow chart of an example process by a STA to transmit a defer signal based on a number of transmissions in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 11 illustrates operations performed in a STA, such as the STA illustrated in FIG. 3.

The process 1100, in operation 1101, the STA determines whether the STA has transmitted or retransmitted a number, K, of times. If the STA determines that it has not transmitted or retransmitted K times, the process proceeds to operation 1103 where the STA performs no action. If the STA determines that it has transmitted or retransmitted the number K times, the process proceeds to operation 1105.

In operation 1105, the STA transmits a defer signal.

In some embodiments, if a device is a part of a restricted target-wake-time (R-TWT) setup, then the device may transmit a defer signal during the quiet period at the start of a service period (SP) to block legacy devices. In some embodiments, if a STA has Emergency Preparedness Communication Services (EPCS) authorization, then the STA can transmit a defer signal. In some embodiments, if a STA has deferred to X number of transmissions, then it can become eligible to transmit the defer signal. In some embodiments, if a STA has deferred for an amount of time, T, then it can become eligible to transmit the defer signal.

In some embodiments, if a STA dropped Y number of packets (e.g., due to a delay bound getting exceeded or a packet expiration due to an STA not being able to capture the channel), then the STA can become eligible to transmit the defer signal. In some embodiments, the metrics described herein (e.g., transmissions, time, number of packets, among others) may be reset once the STA transmits a defer signal.

In some embodiments, the metrics can be computed over a window of time. The window can be a running window or a fixed window. The metrics can be rest at the end of each window if it is a fixed window.

In some embodiments, the thresholds can be specified in the standard or can be advertised by the AP in its advertisement messages (e.g., via beacon frames, probe response frames, (Re)association response frames, among others). In some embodiments, there can be a parameter set element advertised in management frames (e.g., beacons, probe responses, (Re)association responses, among others) which can carry values of parameters or thresholds of prioritized EDCA.

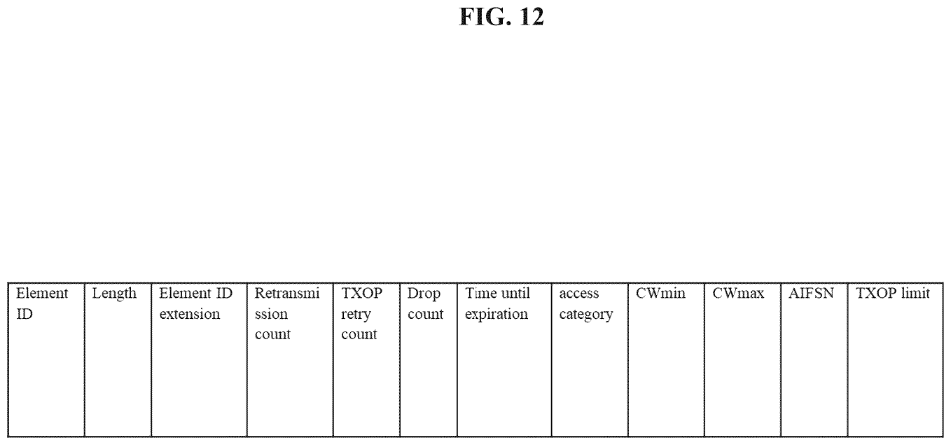

FIG. 12 illustrates a format for a parameter set element in accordance with an embodiment. The element includes an element ID field, a length field, an element ID extension field, a retransmission count field, a TXOP retry count field, a drop count field, a time until expiration field, an access category field, a CWmin field, a CWmax field, an AIFSN field, and a TXOP limit field.

The element ID field may provide an identifier for the element. The length field may provide length information for the element. The element ID extension field may provide extension information for the element. The retransmission count field may be a threshold for the retransmission count threshold for becoming eligible to initiate transmitting a defer signal (e.g. for a prioritized EDCA). The TXOP retry count field may provide a threshold for a number of times the STA did not obtain a TXOP using the prioritized EDCA contention. The drop count field may provide information on a number of times the STA drops a packet to become eligible for using prioritized EDCA. The time until expiration field may provide a threshold for a time until expiration that can be met to become eligible for using prioritized EDCA. The access category field may provide information on a category of traffic that can use the prioritized EDCA. The minimum contention window size (CWmin) field may be a CWmin value for prioritized EDCA contention. The maximum contention window (CWmax) field may be a CWmax value for the prioritized EDCA contention. The arbitration interframe space number (AIFSN) field be an AIFSN value for prioritized EDCA. The transmission opportunity (TXOP) limit field can be a TXOP limit for prioritized EDCA. In some embodiments, one or more of the fields illustrated in the figure can be omitted and other fields may be present.

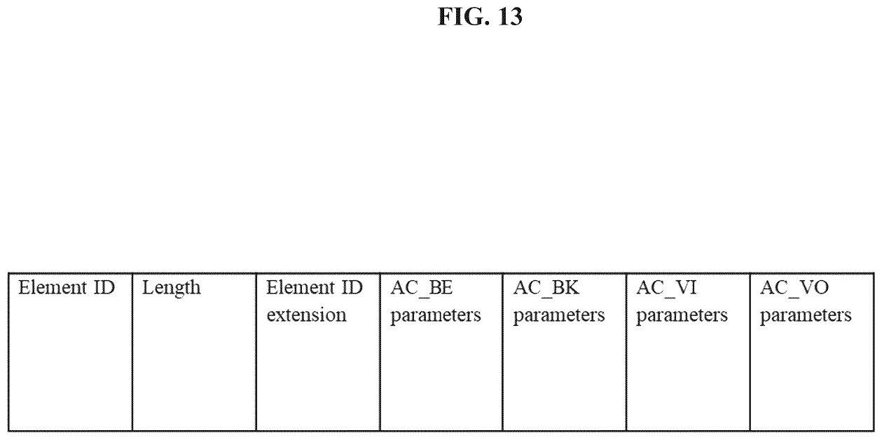

FIG. 13 illustrates a parameter set element format in accordance with an embodiment. The element includes an element ID field, a length field, an element ID extension field, an access category best effort (AC_BE) parameters field, an access category background (AC_BK) parameters field, an access category video (AC_VI) parameters field, and an access category voice (AC_VO) parameters field. The element ID field can include an identifier for the element. The length field may provide length information for the element. The element ID extension field may provide extension information for the element.

The AC BE parameters can provide information on one or more thresholds for AC BE packets. The AC BK parameters can provide information on one or more thresholds for AC BK packets. The AC VI parameters can provide information on one or more thresholds for AC VI packets. The AC VO parameters can provide information on one or more thresholds for AC VO parameters. The parameters can be one or more of the parameters described herein.

In some embodiments, when a device sets up a quality of service (QOS) for a stream whose latency requirement is less than a certain threshold (e.g., channel access delay, 10 ms, among others), then the device can be authorized to transmit a defer signal. The QoS may be setup for example, via an SCS request and response framework

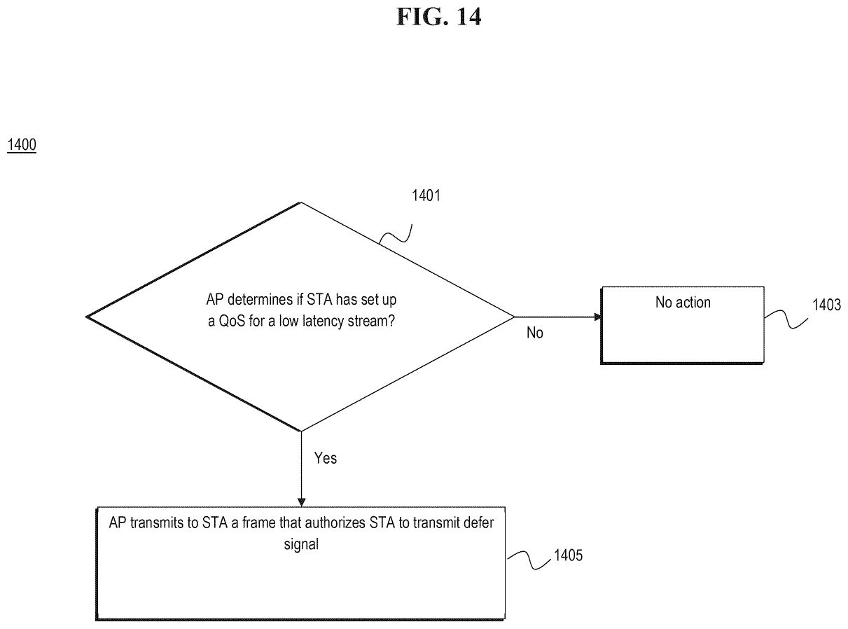

FIG. 14 illustrates a flow chart of an example process for a QoS setup based authorization in accordance with an embodiment. Although one or more operations are described or shown in particular sequential order, in other embodiments the operations may be rearranged in a different order, which may include performance of multiple operations in at least partially overlapping time periods. The flowchart depicted in FIG. 14 illustrates operations performed in a AP, such as the AP illustrated in FIG. 3.

The process 1400, in operation 1401, the AP determines whether the STA has setup a QoS for a low latency stream. If the AP determines that the STA has not setup a QoS for the low latency stream, the process proceeds to operation 1403 where the AP performs no action. If the AP determines that the STA has setup a QoS for the low latency stream, the process proceeds to operation 1405.

In operation 1405, the AP transmits to the STA a frame that authorizes the STA to transmit a defer signal.

In some embodiments, if a device is a part of an R-TWT setup, then the AP can authorize the device to transmit a defer signal during the quiet period at the start of an SP to block legacy devices.

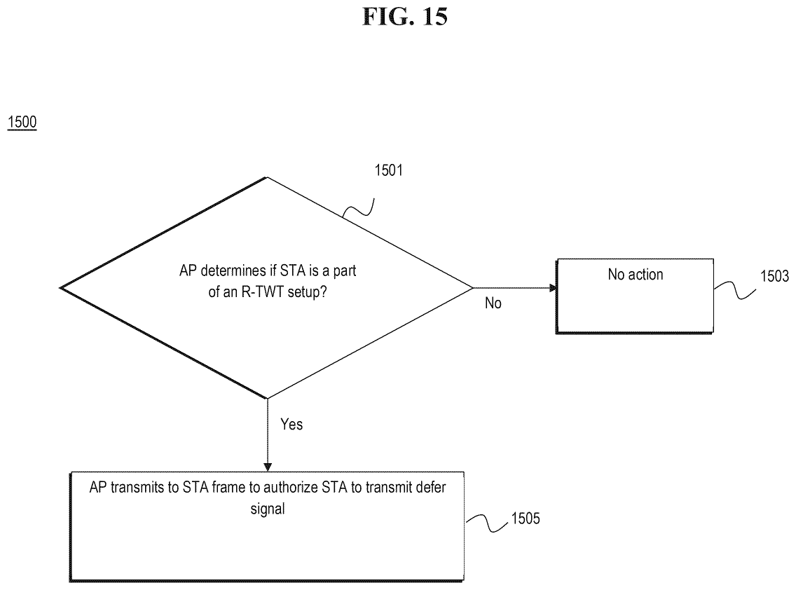

FIG. 15 illustrates a flow chart of an example process by an AP of providing a restricted target-wake-time (R-TWT) setup based authorization in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 15 illustrates operations performed in a AP, such as the AP illustrated in FIG. 3.

The process 1500, in operation 1501, the AP determines whether the STA is a part of an R-TWT setup. If the AP determines that the STA is not part of an R-TWT setup, the process proceeds to operation 1503 where the AP performs no action. If the AP determines that the STA is a part of an R-TWT setup, the process proceeds to operation 1505.

In operation 1505, the AP transmits to the STA a frame that authorizes the STA to transmit a defer signal.

In some embodiments, if a STA has EPCS authorization, then the AP may authorize the STA or the STA can request to be authorized to transmit a defer signal.

In some embodiments, the AP can revoke the membership or authorization of a STA to transmit a defer signal. The AP may revoke the membership of a STA by transmitting a membership revoke message to the STA. The membership revoke message may include at least one or more of the information items as indicated in Table 4.

Table 4 illustrates a membership revoke message in accordance with an embodiment.

TABLE 4

| Information | |
|---|---|
| item | Description |
| Revoke | An information item that can indicate that the AP has revoked the STA's |
| indication | membership or authorization. e.g., a status code. |
| Reason | An information item that can indicate the reason for transmitting the |
| information | revoke message. |
| Start time | An information item that can indicate the time at which the membership or |
| | authorization can be considered to be revoked. e.g., number of TBTTs |
| | from current TBTT, as soon as the message is received, among others. |
| Duration | An information item that can indicate the duration for which the |
| | authorization can be revoked if the revoke is temporary. |

The information items in Table 4 can be transmitted together or separately. They can be transmitted as a part of any existing frame or element or field or subfield in the standard or can be a part of newly defined ones.

In some embodiments, once a STA receives the revoke message from the AP, the STA can cease to transmit the defer signal at the indicated time and, if specified, for the indication duration.

In some embodiments, if an AP determines that the STA is misusing the defer signal (e.g., transmitting the defer signal for traffic frames that do not need the defer signal, transmitting the defer signal when not needed, among others), then the AP can revoke the STA's authorization.

In some embodiments, revoking a membership may mean turning off the prioritized EDCA based channel access. The AP can transmit an indication (e.g., a bit or flag) that can make such an indication. In some embodiments, the bit can take a predetermined value (e.g., 1) to indicate turning on the feature and another predetermined value (e.g., 0) to turn it off.

In some embodiments, if the AP receives a frame from a STA that has been transmitted with the help of a defer signal and the STA is either not authorized to transmit a defer signal or is violating its terms of authorization as specified by the AP when granting the authorization, then the AP can revoke the authorization of the STA. In some embodiments, the AP may disassociate the STA to prevent the STA from becoming a security threat to other devices in the network. For example, if a STA is transmitting a defer signal that is not necessary, then the STA can potentially block other devices in the network.

In some embodiments, the AP can provide the STA with a prioritized EDCA parameter set to contend to gain channel access quickly after transmitting a defer signal. In some embodiments, if the defer signal puts the legacy devices into an Extended Interframe Space (EIFS) state, then the EDCA parameter set can be such that the STA can contend for channel access before the legacy devices recover from EIFS state.

In some embodiments, a STA that has attempted to transmit using a defer signal but has failed to do so for K number of attempts, the STA can become ineligible to transmit the defer signal again until it becomes eligible. Accordingly, in some embodiments, a limit may be placed on a number of consecutive defer signal transmission attempts that may be performed. In some embodiments, a default number of allowed consecutive DS transmission attempts (or retries) may be provided (e.g., 1 or 2 or 3, among others). In some embodiments, a STA may not initiate more than a predetermined number of EDCA contentions. In some embodiments, an AP may advertise values of permitted EDCA contentions that are allowed, and an associated STA may follow the advertised value.

In certain embodiments, the STA can become ineligible for transmission of the defer signal for another M number of attempts. In certain embodiments, the STA can become ineligible to transmit the defer signal for a period of time or until it becomes eligible again.

In some embodiments, a STA that has transmitted the defer signal and a successful transmission after the defer signal can become ineligible for a transmission of the defer signal until it again becomes eligible based on other eligibility criteria.

Embodiment in accordance with this disclosure may apply to multi-link operation with membership being granted on a per link basis. Embodiments in accordance with this disclosure may apply to non-managed networks (e.g., P2P, Mobile AP, among others). Embodiments in accordance with this disclosure may apply to relay networks. For example, a relay can be authorized or can authorize other STAs to transmit the defer signal.

In some embodiments, transmitting a defer signal can lead to a prioritized EDCA channel access phase where the devices that transmitted the defer signal can contend. In some embodiments, an AP can have an exception in this regard.

In some embodiments, the AP can transmit a defer signal to help the STA to gain channel access. The defer signal can be transmitted to enable the AP to transmit control frames to the STA.

In some embodiments, an STA may have setup a QoS request with an AP for a low latency (LL) traffic stream. Accordingly, the AP may have to transmit a trigger frame to the STA. If the STA's traffic is periodic, then the AP can attempt to trigger the STA around the time its LL frames arrive (e.g., as predicted based on the stream's characteristics). However, if the LL traffic's delay tolerance is significantly less than the channel access delay, it may not be possible for the AP to trigger the STA in time. Accordingly, the AP can then transmit a defer signal to block other devices from accessing the channel, so that the AP can transmit the trigger frame in time.

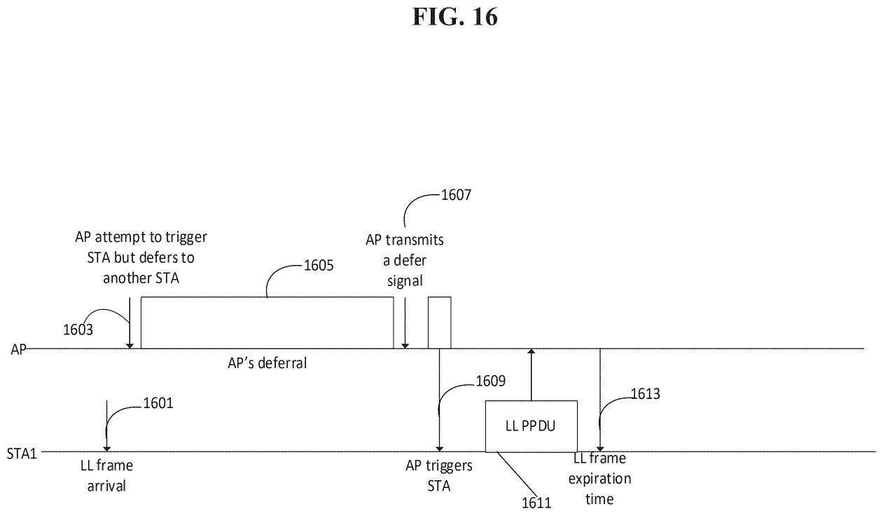

FIG. 16 illustrates an example assistance from an AP in accordance with an embodiment. In particular, FIG. 16 illustrates communication between an AP and an STA. At time 1601, the STA receives a low latency frame. At time 1603, the AP attempts to trigger the STA but defers to another STA, indicated by AP's deferral during time period 1605. At time 1607, the AP transmits a defer signal to block other devices from contenting for channel access and thus provide STA1 with prioritized EDCA. At time 1609, the AP transmits to the STA a trigger frame. The STA transmits a low latency frame (e.g. physical layer protocol data unit (PPDU)) 1611 before the LL frame expiration time at time 1613.

In some embodiments, an AP may block a channel to assist the STA to transmit LL frames (e.g., PPDU). If the STA has setup a QoS for a LL traffic stream, then close to its predicted arrival time, the AP can transmit a defer signal to block other devices. The STA can ignore the defer signal and transmit the LL frame (e.g., PPDU) to the AP. The defer signal can have a unique identifier (e.g., BSS color, among other) in order for the STA to be able to understand that the defer signal is coming from its own AP.

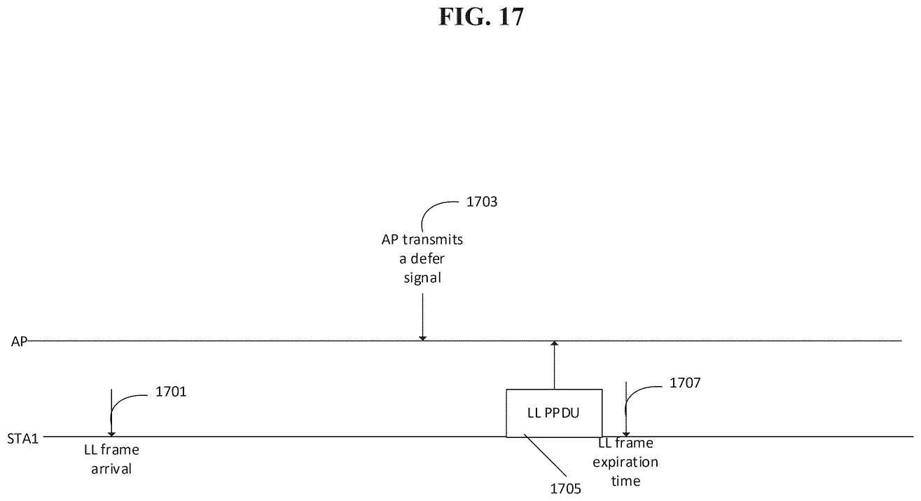

FIG. 17 illustrates an AP clearing a channel for an STA in accordance with an embodiment. In particular, FIG. 17 illustrates communication between AP and STA1. At time 1701, the STA1 receives a LL frame. At time 1703, the AP transmits a defer signal to block other devices from contending for the channel and thus clearing the channel for STA1. Accordingly, STA1 is able to obtain channel access and transmits to the AP a LL PPDU frame 1705 after ignoring the defer signal, and before the indicated LL frame expiration time 1707 while other STAs defer their transmissions.

In some embodiments, the STA can provide timing information to the AP (e.g., expiry time of its frames) and the AP can transmit a defer signal such that the STA transmits the frame prior to expiration time. The STA can ignore the defer signal and transmit the urgent frame to the AP.

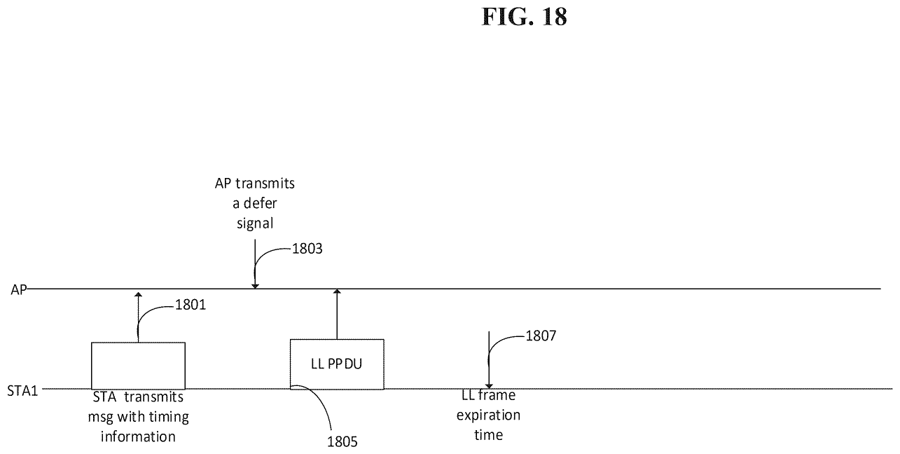

FIG. 18 illustrates an AP transmitting a defer signal based on an indication by the STA in accordance with an embodiment. In particular, FIG. 18 illustrates communication between an AP and an STA1. The STA1 transmits to the AP a frame 1801 that includes timing information which indicates a frame expiration at time 1807. At time 1803, the AP transmits to the STA defer signal. Accordingly, prior to the LL frame expiration time 1807, the STA transmits to the AP a LL PPDU frame 1805.

In some embodiments, the AP can transmit a defer signal to block other STAs at the start of an R-TWT service period (SP) to aid LL STAs to gain channel access faster.

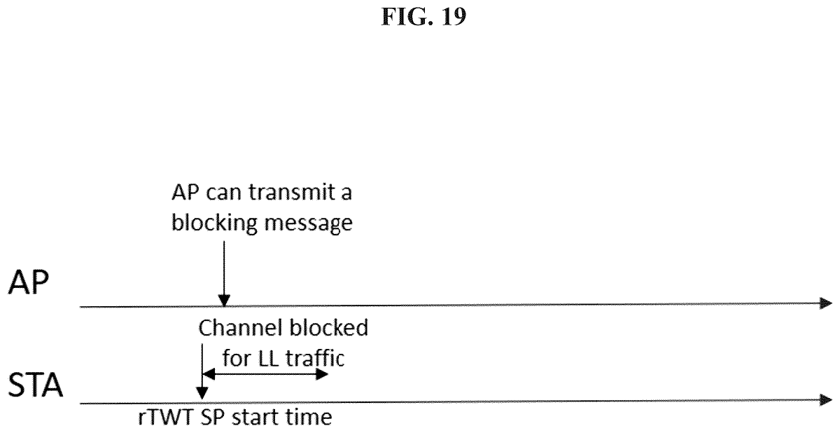

FIG. 19 illustrates an AP transmitting a defer signal to aid a low latency STA at the start of an R-TWT SP in accordance with an embodiment. In particular, FIG. 19 illustrates communication between an AP and an STA. Time 1901 indicates the R-TWT SP start time for the STA. At time 1903, the AP transmits a defer signal that blocks the channel from other STAs Accordingly, the channel is blocked for LL traffic of the STA.

In some embodiments, the AP can transmit a defer signal to clear the channel for non-managed network operation (e.g., Mobile AP, peer-to-peer (P2P) devices, among others). The AP can determine the need to transmit the defer signal based on the knowledge of QoS requirements of such networks.

In some embodiments, the AP can transmit a defer signal in response to the defer signal transmitted by the STAs. This response defer signal can enable the STAs to understand that their defer signal is approved by the AP. If the AP does not want the STAs to block the channel, the AP can refrain from transmitting a defer signal and in response transmit an unblocking signal. In some embodiments, the AP may transmit an unblocking signal by transmitting a frame with a PHY.RXEND.indication primitive that does not include an error or a frame for which the frame check sequence (FCS) value has a high chance of not being incorrect such as a short PPDU transmission.

Embodiments in accordance with this disclosure may allow an STA to obtain authorization from an AP to transmit defer signals (blocking messages) that block other STAs from accessing the channel to reduce the amount of contention on the wireless medium. This can be done by a STA with a low latency traffic backlog by sending a defer signal to block other devices (e.g., devices that cannot or have not transmitted such a signal, among others) from contending for the wireless medium for a certain period of time. An AP may control the number of devices that can send such a defer signal to help reduce channel access latency and improve network performance.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
transmit a defer signal to block one or more STAs from contending for a channel during a time period;
contend for the channel and obtain access to the channel; and
transmit, to an access point (AP), one or more frames via the channel.

2. The STA of claim 1, wherein the processor is further configure to:
transmit, to the AP, a first frame that requests authorization to transmit a defer signal that blocks one or more other STAs associated with the AP from contending for a channel; and
receive, from the AP, a second frame that authorizes the transmission of the defer signal in response to the first frame.

3. The STA of claim 1, wherein the processor is further configured to determine that a number of retransmissions of a frame is greater than a threshold prior to transmitting the defer signal.

4. The STA of claim 1, wherein the processor is further configured to determine that a buffering delay for transmitting a frame is greater than a predetermined threshold prior to transmitting the defer signal.

5. The STA of claim 1, wherein the processor is further configured to determine that a number of transmission attempts of the defer signal is less than a threshold prior to transmitting the defer signal.

6. The STA of claim 1, wherein the processor is further configured to:
receive, from the AP, a frame that revokes the authorization to transmit the defer signal; and
abstain from transmitting the defer signal in response to receiving the frame.

7. The STA of claim 1, wherein the processor is further configured to:
receive, from the AP, a frame that includes a prioritized enhanced distributed channel access parameter set that provides high priority to the STA that is allowed to transmit low latency traffic.

8. The STA of claim 1, wherein the processor is further configured to:
determine that a particular frame is within a threshold of an expiration time of the particular frame prior to transmitting the defer signal.

9. The STA of claim 1, wherein the processor is further configured to:
receive, from the AP, a frame that includes one or more information associated with eligibility for transmitting the defer signal.

10. The STA of claim 1, wherein the processor is further configured to:
receive, from the AP, a frame that advertises one or more thresholds for becoming eligible to transmit the defer signal.

11. An access point (AP) in a wireless network, the AP comprising:
a memory; and
a processor coupled to the memory, the processor configured to:
receive, from a station (STA), a first frame that requests authorization to transmit a defer signal that blocks one or more other STAs associated with the AP from contending for a channel;
transmit, to the STA, a second frame that authorizes the transmission of the defer signal in response to the first frame; and
receive, from the STA, one or more frames via the channel.

12. The AP of claim 11, wherein the processor is further configured to:
transmit, to the STA, a frame that revokes the authorization to transmit the defer signal.

13. The AP of claim 11, wherein the second frame includes a prioritized enhanced distributed channel access parameter set that provides high priority to the STA that is allowed to transmit low latency traffic.

14. The AP of claim 11, wherein the first frame includes timing information regarding an expiration time of a particular frame of the STA.

15. The AP of claim 11, wherein the second frame includes one or more information associated with eligibility for transmitting the defer signal.

16. A computer-implemented method for communication by a station (STA) in a wireless network, comprising:
transmitting a defer signal to block one or more STAs from contending for the channel during a time period;
contending for the channel and obtain access to the channel; and
transmitting, to the AP, one or more frames via the channel.

17. The computer-implemented method of claim 16, further comprising:
transmitting, to the AP, a first frame that requests authorization to transmit a defer signal that blocks one or more other STAs associated with the AP from contending for a channel; and
receiving, from the AP, a second frame that authorizes the transmission of the defer signal in response to the first frame.

18. The computer-implemented method of claim 16, further comprising determining that a number of retransmissions of a frame is greater than a threshold prior to transmitting the defer signal.

19. The computer-implemented method of claim 16, further comprising determining that a buffering delay for transmitting a frame is greater than a predetermined threshold prior to transmitting the defer signal.

20. The computer-implemented method of claim 16, further comprising determining that a number of transmission attempts of the defer signal is less than a threshold prior to transmitting the defer signal.
